(19) United States
(12) Patent Application Publication
(10) Pub. No.: US 2021/0006685 A1
(43) Pub. Date: Jan. 7, 2021

(54) IMAGE FORMING APPARATUS CAPABLE OF CONNECTING EXTERNAL STORAGE DEVICE, CONTROL METHOD THEREFOR, AND STORAGE MEDIUM STORING PROGRAM FOR EXECUTING CONTROL METHOD

(71) Applicant: CANON KABUSHIKI KAISHA, Tokyo (JP)

(72) Inventor: Masato Fukuda, Kashiwa-shi (JP)

(21) Appl. No.: 16/902,635

(22) Filed: Jun. 16, 2020

(30) Foreign Application Priority Data
Jul. 2, 2019 (JP) 2019-123822

(51) Int. Cl. H04N 1/44; G06F 3/12; H04N 1/00

(52) U.S. Cl. CPC H04N 1/4433; G06F 3/1238; H04N 1/00482; H04N 1/0048; H04N 1/00474; G06F 3/1204

(57) ABSTRACT

An image forming apparatus that is capable of improving usability at a time of using a specific function that uses an external storage device. The image forming apparatus includes a memory device that stores a set of instructions, and at least one processor that executes the set of instructions to display, in a case where a function that is selectable by a user is uniquely specified from among specific functions that use an external storage device connected, a setting screen concerning the uniquely specified function in response to connection of the external storage device, and to display a selection screen that prompts the user to select a use function from among the specific functions in response to connection of the external storage device in a case where a function that is selectable by the user is not uniquely specified from among the specific functions.

### BACKGROUND OF THE INVENTION

### Field of the Invention

The present invention relates to an image forming apparatus capable of connecting an external storage device, a control method therefor, and a storage medium storing a program for executing the control method.

### Description of the Related Art

There is a known image forming apparatus that is capable of connecting an external storage device, such as a USB memory. The image forming apparatus is provided with specific functions (hereinafter referred to as “external-memory-device use functions”) that use the external storage device. There are a media scan function and a media print function as the external-memory-device use functions, for example. The media scan function controls an image forming apparatus to scan a document, to generate image data of the document concerned, and to store the generated image data in an external storage device. The media print function controls an image forming apparatus to obtain print data from an external storage device and to perform a print process on the basis of the obtained print data.

When an external storage device is connected to an image forming apparatus that is provided with these functions as the external-memory-device use functions, the image forming apparatus displays a selection screen that inquires of a user which of the media scan function and the media print function will be used. The image forming apparatus displays a setting screen about the function that is selected by the user on the selection screen (for example, Japanese Laid-Open Patent Publication (Kokai) No. 2006-110860 (JP 2006-110860A)).

Incidentally, some image forming apparatuses allow a manager to set a function restriction that restricts a part of functions of the image forming apparatus. For example, a manager sets to restrict use of the media scan function in order to prevent leakage of secret information, such as a case where scanned image data of an important document is stored in an external storage device and it is carried away outside. This setting allows the image forming apparatus to use only the media print function from among the media scan function and the media print function that are the external-memory-device use functions.

In the meantime, when a printer of the image forming apparatus breaks down or when a toner remaining amount of the image forming apparatus is zero, only the media scan function is usable from among the media scan function and the media print function that are the external-memory-device use functions. As mentioned above, when only one function is usable as the external-memory-device use function, displaying of the selection screen that inquires of a user to select one of the external-memory-device use functions forces an unnecessary selection operation upon a user. This causes a problem that lowers usability at a time of using an external-memory-device use function.

### SUMMARY OF THE INVENTION

The present invention provides an image forming apparatus that is capable of improving usability at a time of using a specific function that uses an external storage device, a control method therefor, and a storage medium storing a program for executing the control method.

Accordingly, a first aspect of the present invention provides an image forming apparatus including a memory device that stores a set of instructions, and at least one processor that executes the set of instructions to display, in a case where a function that is selectable by a user is uniquely specified from among specific functions that use an external storage device connected, a setting screen concerning the uniquely specified function in response to connection of the external storage device, and to display a selection screen that prompts the user to select a use function from among the specific functions in response to connection of the external storage device in a case where a function that is selectable by the user is not uniquely specified from among the specific functions.

Accordingly, a second aspect of the present invention provides An image forming apparatus including a memory device that stores a set of instructions, and at least one processor that executes the set of instructions to display a function restriction setting screen that enables setting of restricting use of at least one of a first function and a second function that use an external storage device connected, to display a selection screen that prompts a user to select a use function from among the first function and the second function in response to connection of the external storage device in a case where use of neither the first function nor the second function is restricted based on the setting on the function restriction setting screen, and to display, in a case where use of one of the first function and the second function is restricted based on the setting on the function restriction setting screen, a setting screen concerning a function of which use is not restricted based on the setting on the function restriction setting screen.

Accordingly, a third aspect of the present invention provides a control method for an image forming apparatus, the control method including displaying, in a case where a function that is selectable by a user is uniquely specified from among specific functions that use an external storage device connected, a setting screen concerning the uniquely specified function in response to connection of the external storage device, and displaying a selection screen that prompts the user to select a use function from among the specific functions in response to connection of the external storage device in a case where a function that is selectable by the user is not uniquely specified from among the specific functions.

Accordingly, a fourth aspect of the present invention provides a control method for an image forming apparatus, the control method including displaying a function restriction setting screen that enables setting of restricting use of at least one of a first function and a second function that use an external storage device connected, displaying a selection screen that prompts a user to select a use function from among the first function and the second function in response to connection of the external storage device in a case where use of neither the first function nor the second function is restricted based on the setting on the function restriction setting screen, and displaying, in a case where use of one of the first function and the second function is restricted based on the setting on the function restriction setting screen, a setting screen concerning a function of which use is not restricted based on the setting on the function restriction setting screen in response to connection of the external storage device.

Accordingly, a fifth aspect of the present invention provides a non-transitory computer-readable storage medium storing a control program causing a computer to execute the control method of the third aspect.

Accordingly, a sixth aspect of the present invention provides a non-transitory computer-readable storage medium storing a control program causing a computer to execute the control method of the fourth aspect.

The present invention improves the usability at the time of using the specific function that uses the external storage device.

Further features of the present invention will become apparent from the following description of exemplary embodiments with reference to the attached drawings.

### BRIEF DESCRIPTION OF THE DRAWINGS

FIG. 1 is a block diagram schematically showing a configuration of an image forming apparatus concerning an embodiment of the present invention.

FIG. 2 is a block diagram schematically showing a configuration of software modules of the image forming apparatus shown in FIG. 1.

FIG. 3 is a view showing an example of a function restriction setting screen displayed on an operation unit shown in FIG. 1.

FIG. 4A and FIG. 4B are views showing examples of a function restriction information table in FIG. 1.

FIG. 5 is a view showing screen transition of a case where the image forming apparatus in FIG. 1 is able to use both a media scan function and a media print function.

FIG. 6 is a view showing screen transition of a case where the image forming apparatus in FIG. 1 is able to use only the media scan function from among the media scan function and the media print function.

FIG. 7 is a view showing screen transition of a case where the image forming apparatus in FIG. 1 is able to use only the media print function from among the media scan function and the media print function.

FIG. 8 is a flowchart showing procedures of a first display control process executed by the image forming apparatus in FIG. 1.

FIG. 9 is a view showing screen transition of a case where the image forming apparatus in FIG. 1 is able to use both the media scan function and the media print function.

FIG. 10 is a flowchart showing procedures of a second display control process executed by the image forming apparatus in FIG. 1.

### DESCRIPTION OF THE EMBODIMENTS

Hereafter, an embodiment according to the present invention will be described in detail by referring to the drawings. It should be noted that the embodiment does not restrict the scope of the present invention defined by the claims. Not all of the combinations of features described in the embodiment are indispensable to solutions of the present invention.

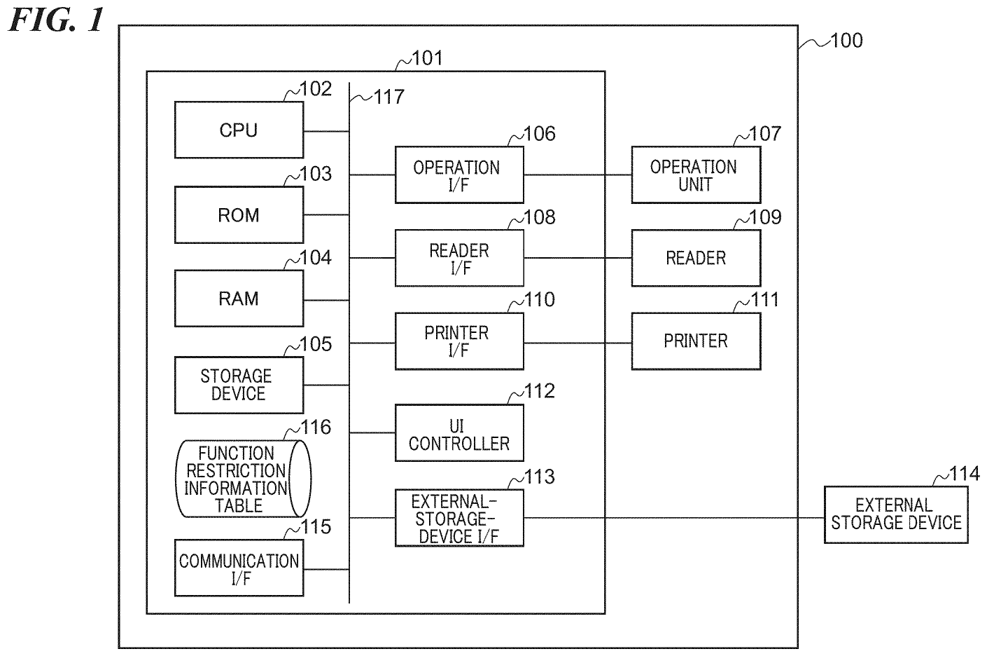

FIG. 1 is a block diagram schematically showing a configuration of an image forming apparatus 100 concerning the embodiment of the present invention.

As shown in FIG. 1, the image forming apparatus 100 is provided with a controller 101, an operation unit 107, a reader 109, and a printer 111. The image forming apparatus 100 is an MFP (Multi-Function Peripheral) equipped with a print function and a scan function, for example. The image forming apparatus 100 is provided with external-memory-device use functions that are specific functions to use an external storage device 114 connected to the image forming apparatus 100. There are a media scan function and a media print function as the external-memory-device use functions, for example. The media scan function controls the image forming apparatus 100 to scan a document with the reader 109, to generate image data of the document concerned, and to store the generated image data in the external storage device 114. The media print function controls an image forming apparatus 100 to perform a print process on the basis of print data stored in the external storage device 114 with the printer 111.

The controller 101 is connected to the operation unit 107, reader 109, and printer 111. Moreover, the controller 101 is provided with a CPU 102, a ROM 103, a RAM 104, a storage device 105, an operation I/F 106, a reader I/F 108, a printer I/F 110, a UI controller 112, an external storage device I/F 113, and a communication I/F 115. The CPU 102, ROM 103, RAM 104, storage device 105, operation I/F 106, reader I/F 108, printer I/F 110, UI controller 112, external storage device I/F 113, and communication I/F 115 are mutually connected through a bus 117.

The CPU 102 controls the entire image reading apparatus 100. The CPU 102 runs programs stored in the ROM 103 or the storage 105 to perform various control operations, such as a read control operation and a print control operation. The ROM 103 stores programs that are executed by the CPU 102. The RAM 104 is a main memory of the CPU 102. The RAM 104 is used as a working area of the CPU 102. Moreover, the RAM 104 is used as a temporary storage area to which a program stored in the ROM 103 or the storage device 105 is developed. The storage device 105 stores print data, image data, programs, setting data, etc.

In the embodiment, the storage device 105 stores a function restriction information table 116 that is used to manage use propriety information about the external-memory-device use functions. Although the embodiment discloses a configuration in which one CPU 102 executes various processes mentioned later using one RAM 104, another configuration may be employed. For example, a plurality of CPUs, RAMs, ROMs, and storage devices may execute the various processes mentioned later in cooperation. Moreover, a part of the processes may be executed using hardware circuits, such as an ASIC (Application Specific Integrated Circuit) and an FPGA (Field-Programmable Gate Array).

The operation I/F 106 is connected to the operation unit 107. The operation unit 107 is controlled by UI controller 112 and displays various screens. When a user operates the operation unit 107, the image forming apparatus 100 obtains an event corresponding to a user's operation through the operation I/F 106. The reader I/F 108 is connected to the reader 109. The reader 109 has a document feeder (not shown) and is able to read documents stacked on the document feeder by conveying the documents one-by-one. The reader 109 generates image data of a read document. The image data concerned is stored in the storage device 105 or the external storage device 114 that is connected to the external storage device I/F 113.

The printer I/F 110 is connected to the printer 111. The printer I/F 110 transmits a control command and image data to the printer 111. The printer I/F 110 transmits image data generated by the reader 109 and print data stored in the external storage device 114 to the printer 111. The printer 111 prints an image onto a sheet according to a control command and image data received. A printing system of the printer 111 is an electrophotographic system or an ink jet system, for example. When the electrophotographic system is employed, the printer 111 prints an image by forming an electrostatic latent image on a photosensitive member, developing the image by toner, transferring a toner image to a sheet, and fixing the toner image transferred. In the meantime, when the ink jet system is employed, the printer 111 prints an image onto a sheet by ejecting inks.

The UI controller 112 controls the operation unit 107 through the operation I/F 106. Specifically, the UI controller 112 displays a user notice, choices, etc. on the operation unit 107 and notifies other function units of an operation content when receiving a user's operation to the operation unit 107. The external storage device I/F 113 is connected to the external storage device 114. The external storage device 114 is a USB memory or an SD card, for example.

The image forming apparatus 100 performs a control operation that stores data stored in the external storage device 114 to the storage device 105 through the external storage device I/F 113 and a control operation that controls the printer 111 to print on the basis of print data stored in the external storage device 114. Moreover, the image forming apparatus 100 performs a control operation for writing data stored in the storage device 105 and for writing image data generated by the reader 109 into the external storage device 114 through the external storage device I/F 113.

The communication I/F 115 is an interface that enables the image forming apparatus 100 to communicate with an external apparatus connected through a network (not shown). For example, the image forming apparatus 100 analyzes print data received through the communication I/F 115 with a PDL analysis module (not shown) that is a software module. The PDL analysis module generates data that is printed by the printer 111 on the basis of print data described in the page description language.

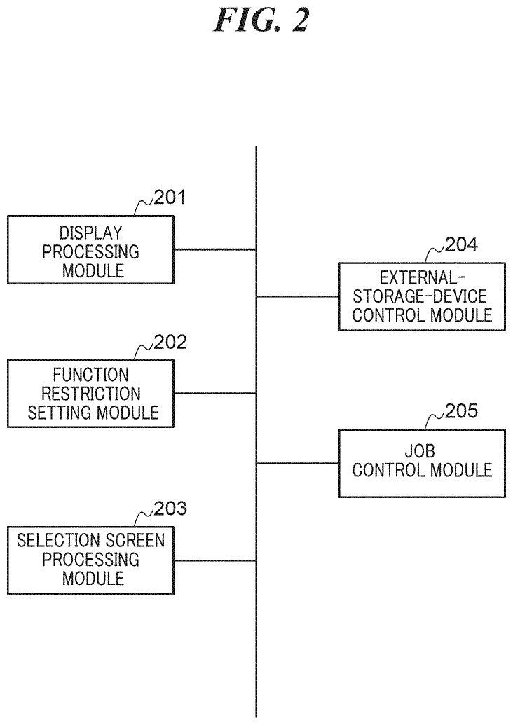

FIG. 2 is a block diagram schematically showing a configuration of software modules of the image forming apparatus shown in FIG. 1. As shown in FIG. 2, the image forming apparatus 100 is provided with a display processing module 201, a function restriction setting module 202, a selection screen processing module 203, an external-memory-device control module 204, and a job control module 205 as software modules. Processes by the above-mentioned modules are achieved when the CPU 102 executes programs stored in the ROM 103 and the storage device 105.

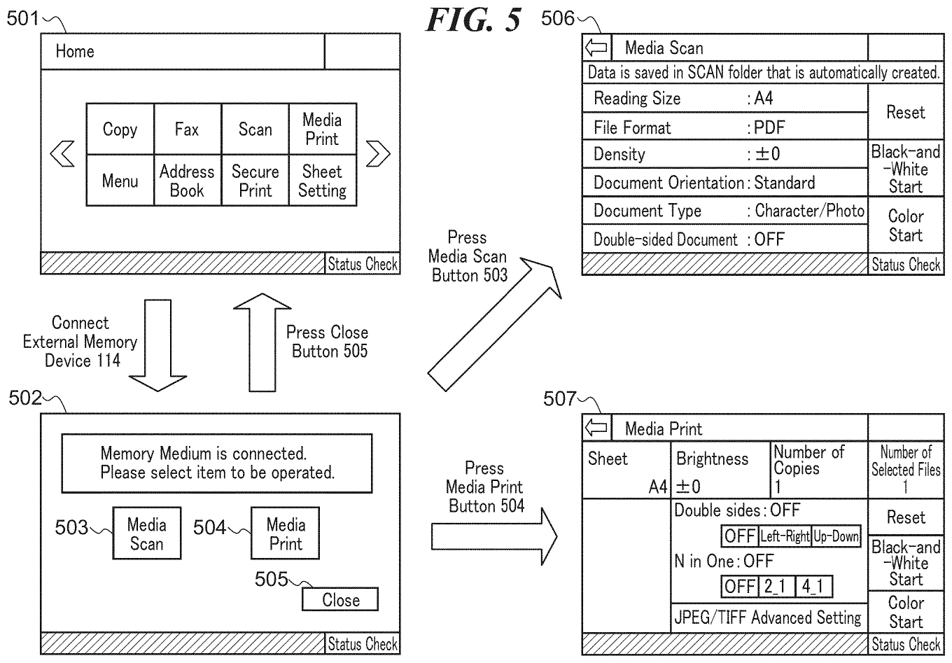

The display processing module 201 controls the UI controller 112 in response to a predetermined operation by a user to switch screens on the operation unit 107. For example, when a user sets a document to the document reader 109, the display processing module 201 detects occurrence of a reading document set event through the reader I/F 108. The reading document set event shows that a document has been set to the reader 109. When detecting occurrence of the reading document set event, the display processing module 201 controls the UI controller 112 to switch a current screen displayed on the operation unit 107 to a setting screen about a scan function. For example, a media scan screen 506 in FIG. 5 mentioned later is displayed.

Moreover, when a user sets a sheet to the printer 111, the display processing module 201 detects occurrence of a sheet set event through the printer I/F 110. The sheet set event shows that a sheet has been set to the printer 111. When detecting occurrence of the sheet set event, the display processing module 201 controls the UI controller 112 to switch a current screen displayed on the operation unit 107 to a setting screen about a print function. For example, a media print screen 507 in FIG. 5 mentioned later is displayed.

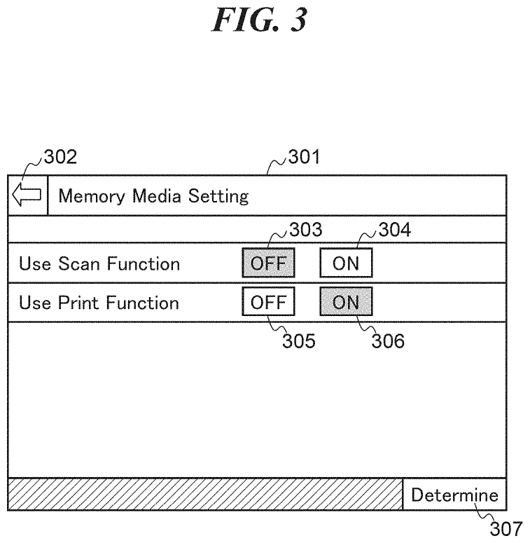

The function restriction setting module 202 manages use propriety information about the media scan function and media print function. When a user sets up the use propriety information on a function restriction setting screen 301 in FIG. 3 mentioned later, the function restriction setting module 202 records a setting value that the user entered into the function restriction information table 116 stored in the storage device 105.

When the external storage device 114 is connected to the image forming apparatus 100, the selection screen processing module 203 displays a selection screen 502 in FIG. 5 mentioned later on the operation unit 107 in order to prompt a user to select a use function from among the external-memory-device use function. In the embodiment, when a user connects the external storage device 114 to the image forming apparatus 100, the display processing module 201 receives a notice showing this connection from the external-memory-device control module 204. When receiving this notice, the display processing module 201 controls the selection screen processing module 203 to display the selection screen 502 etc. mentioned later on the operation unit 107 by referring to the function restriction information table 116.

The external-memory-device control module 204 controls reading and writing of data to the external storage device 114. For example, when a user connects the external storage device 114 to the image forming apparatus 100, the external-memory-device control module 204 outputs the notice showing this connection to the display processing module 201. In the meantime, when the user disconnects the external storage device 114 from the image forming apparatus 100, the external-memory-device control module 204 outputs a notice showing this disconnection to the display processing module 201.

When receiving an execution instruction of a job that uses the media scan function from a user, the external-memory-device control module 204 writes image data generated by the reader 109 into the external storage device 114 through the external storage device I/F 113. Moreover, when receiving an execution instruction of a job that uses the media print function from a user, the external-memory-device control module 204 reads print data from the external storage device 114 through the external storage device I/F 113.

The job control module 205 executes a job corresponding to a notice received from the operation unit 107 or the external-memory-device control module 204. The job control module 205 processes supplied jobs in a certain order by outputting notices that are instructions to the other function modules at suitable timings. Moreover, the job control module 205 gives instructions of starting processes to the other function modules at a time of the power ON of the image forming apparatus 100.

FIG. 3 is a view showing an example of a function restriction setting screen 301 displayed on the operation unit 107 shown in FIG. 1. The function restriction setting screen 301 includes a back button 302, scan function OFF button 303, scan function ON button 304, print function OFF button 305, print function ON button 306, and determination button 307.

When a user presses the back button 302, the display processing module 201 displays a screen that was displayed on the operation unit 107 just before the function restriction setting screen 301 is displayed on the operation unit 107.

When the scan function OFF button 303 is selected, the image forming apparatus 100 disables the media scan function. When the scan function ON button 304 is selected, the image forming apparatus 100 enables the media scan function. In the function restriction setting screen 301, either of the scan function OFF button 303 and the scan function ON button 304 is selected, and the selected button is highlighted. The scan function ON button 304 is highlighted in FIG. 3, for example.

When the print function OFF button 305 is selected, the image forming apparatus 100 disables the media print function. When the print function ON button 306 is selected, the image forming apparatus 100 enables the media print function. In the function restriction setting screen 301, either of the print function OFF button 305 and the print function ON button 306 is selected, and the selected button is highlighted. The pint function OFF button 305 is highlighted in FIG. 3, for example. The determination button 307 is used to fix the setting values set on the function restriction setting screen 301. When a user presses the determination button 307, the function restriction setting module 202 records the setting values set on the function restriction setting screen 301 into the function restriction information table 116.

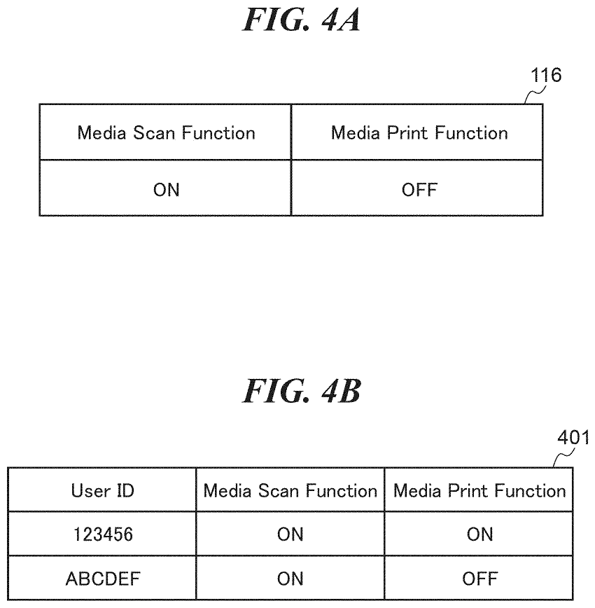

FIG. 4A and FIG. 4B are views showing examples of the function restriction information table 116 in FIG. 1. For example, when the image forming apparatus 100 is not provided with a user login function that needs user authentication at a time of login, one setting value showing use propriety of each of the media scan function and media print function is set up as shown in FIG. 4A. In such an image forming apparatus 100, the function restriction of the same contents is applied to all users who use the image forming apparatus 100 on the basis of the function restriction information table 116 of FIG. 4A. In the meantime, when the image forming apparatus 100 is provided with the user login function, the setting values showing the use propriety of each of the media scan function and media print function are set up for respective users as shown in a function restriction information table 401 of FIG. 4B. In such an image forming apparatus 100, the function restriction corresponding to a user who uses this image forming apparatus 100 is applied on the basis of the function restriction information table 401.

In the embodiment, when displaying the function restriction setting screen 301, the display processing module 201 obtains the setting values showing the use propriety of the media scan function and media print function from the function restriction information table 116 (or the function restriction information table 401). The display processing module 201 displays the function restriction setting screen 301 in which a button corresponding to a function of which the obtained setting value is ON is highlighted on the operation unit 107. For example, the display processing module 201 displays the function restriction setting screen 301 in which the scan function ON button 304 and the print function OFF button 305 are highlighted on the operation unit 107 on the basis of the setting values obtained from the function restriction information table 116 of FIG. 4A.

Moreover, when the image forming apparatus 100 equipped with the user login function receives a display instruction of the function restriction setting screen 301 from a user whose user ID is “123456”, the display processing module 201 obtains the setting values corresponding to the user ID “123456” from the function restriction information table 401 of FIG. 4B.

The display processing module 201 displays the function restriction setting screen 301 in which the scan function ON button 304 and the print function ON button 306 are highlighted on the operation unit 107 on the basis of the setting values obtained. When the image forming apparatus 100 equipped with the user login function receives a display instruction of the function restriction setting screen 301 from a user whose user ID is “ABCDEF”, the display processing module 201 obtains the setting values corresponding to the user ID “ABCDEF” from the function restriction information table 401 of FIG. 4B. The display processing module 201 displays the function restriction setting screen 301 in which the scan function ON button 304 and the print function OFF button 305 are highlighted on the operation unit 107 on the basis of the setting values obtained.

Although the case where the setting values that the user sets up from the function restriction setting screen 301 are recorded into the function restriction information table 116 is described in the embodiment, it is not restricted to this. For example, when the image forming apparatus 100 is provided with a failure detector to detect failure states of the reader 109 and printer 111, the function restriction information table 116 may be updated on the basis of the detection result of the failure states. Specifically, when the failure state of the reader 109 is detected, the function restriction setting module 202 records the setting value showing that the media scan function is unavailable into the function restriction information table 116. Moreover, when the failure state of the printer 111 is detected, the function restriction setting module 202 records the setting value showing that the media print function is unavailable into the function restriction information table 116.

Moreover, the function restriction information table 116 may be updated on the basis of j ob-execution propriety states of the reader 109 and the printer 111. For example, when a state, such as sheet empty or out of toner, that disables a print job is detected, the function restriction setting module 202 records the setting value showing that the media print function is unavailable into the function restriction information table 116.

In the embodiment, a mode of screen transition on the operation unit 107 depends on the use propriety states of the media scan function and media print function in the image forming apparatus 100. Hereinafter, the screen transition on the operation unit 107 for the use propriety states of the media scan function and media print function will be described.

FIG. 5 is a view showing screen transition of a case where the image forming apparatus 100 in FIG. 1 is able to use both the media scan function and media print function.

When the image forming apparatus 100 is started, a home screen 501 is displayed on the operation unit 107 as shown in FIG. 5. The home screen 501 prompts a user to select a use function from among the functions of the image forming apparatus 100. When a user connects the external storage device 114 to the image forming apparatus 100 in the state where the home screen 501 is displayed on the operation unit 107, the home screen 501 displayed on the operation unit 107 is switched to the selection screen 502.

The selection screen 502 prompts a user to select a use function from among the media scan function and media print function that are the external-memory-device use functions. The selection screen 502 includes a media scan button 503, media print button 504, and close button 505.

For example, when a user presses the close button 505 on the selection screen 502, the display processing module 201 controls the UI controller 112 to switch the selection screen 502 displayed on the operation unit 107 to the home screen 501.

When a user presses the media scan button 503 on the selection screen 502, the display processing module 201 controls the UI controller 112 to switch the selection screen 502 displayed on the operation unit 107 to the media scan screen 506. The media scan screen 506 prompts a user to set up the media scan setting values that are needed for execution of a job that uses the media scan function. For example, the setting values include a reading size, a file format, etc.

The user is able to instruct execution of the job that uses the media scan function by pressing a start key (not shown) after setting up the media scan setting values on the media scan screen 506. When the execution instruction of the job concerned is received, the reader 109 that received the notice from the job control module 205 reads the set document on the basis of the set-up media scan setting values and generates image data of the document concerned. The image data of the document is stored into the external storage device 114.

When a user presses the media print button 504 on the selection screen 502, the display processing module 201 controls the UI controller 112 to switch the selection screen 502 displayed on the operation unit 107 to the media print screen 507. The media print screen 507 prompts a user to set up the media print setting values that are needed for execution of a job that uses the media print function. For example, the setting values include a sheet size, a print data name, etc. The user is able to instruct execution of the job that uses the media print function by pressing the start key after setting up the media print setting values on the media print screen 507. When the execution instruction of the job concerned is received, the printer 111 that received the notice from the job control module 205 prints according to the print data stored in the external storage device 114 on the basis of the set-up media print setting values.

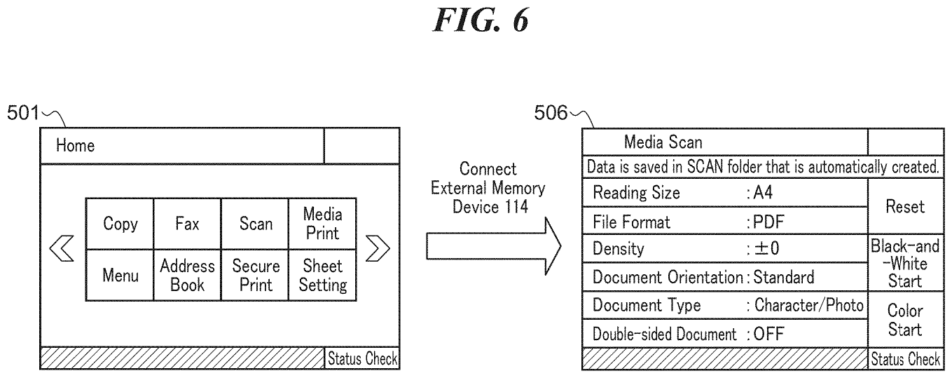

FIG. 6 is a view showing screen transition of a case where the image forming apparatus 100 in FIG. 1 is able to use only the media scan function. When a user connects the external storage device 114 to the image forming apparatus 100 in the state where the home screen 501 is displayed on the operation unit 107, the display processing module 201 controls the UI controller 112 to switch the home screen 501 displayed on the operation unit 107 to the media scan screen 506 as shown in FIG. 6 without switching to the selection screen 502. The user is able to set up the media scan function of which use is not restricted in the function restriction information table 116 on the media scan screen 506.

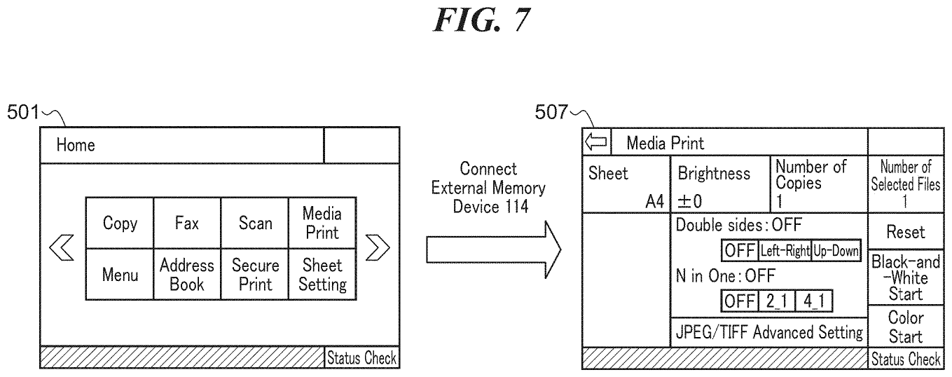

FIG. 7 is a view showing screen transition of a case where the image forming apparatus 100 in FIG. 1 is able to use only the media print function. When a user connects the external storage device 114 to the image forming apparatus 100 in the state where the home screen 501 is displayed on the operation unit 107, the display processing module 201 controls the UI controller 112 to switch the home screen 501 displayed on the operation unit 107 to the media print screen 507 as shown in FIG. 7 without switching to the selection screen 502. The user is able to set up the media print function of which use is not restricted in the function restriction information table 116 on the media print screen 507.

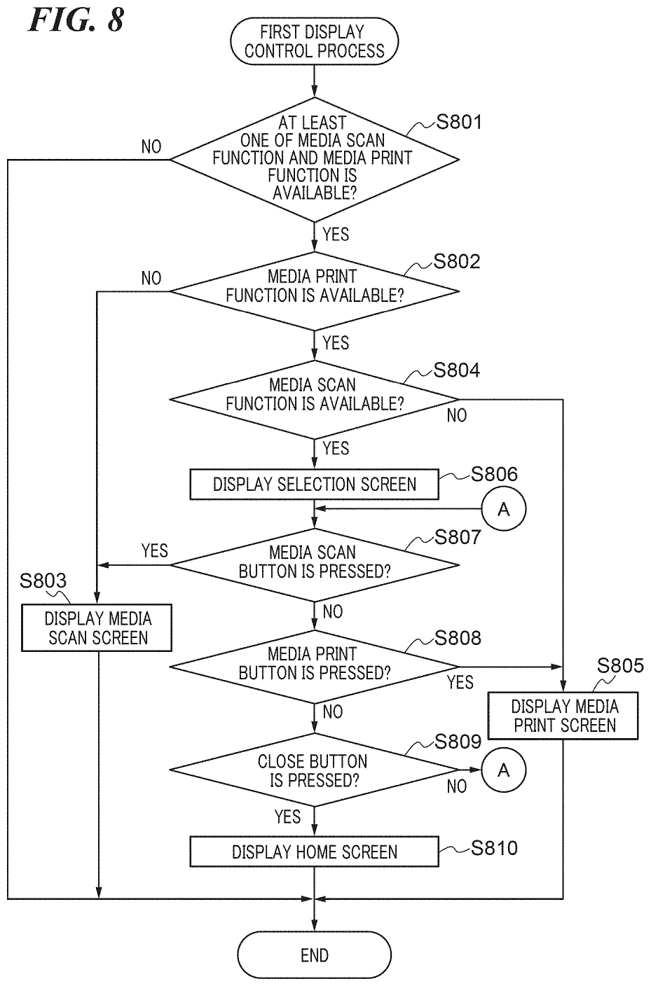

FIG. 8 is a flowchart showing procedures of a first display control process executed by the image forming apparatus in FIG. 1. The process in FIG. 8 is achieved when the CPU 102 executes programs stored in the ROM 103 and the storage device 105. The process in FIG. 8 is executed when connection of the external storage device 114 to the image forming apparatus 100 is detected in the state where the home screen 501 is displayed on the operation unit 107.

As shown in FIG. 8, the CPU 102 first refers to the function restriction information table 116 stored in the storage device 105 and determines whether at least one of the media scan function and media print function is available (step S801).

As a result of the determination in the step S801, when both the media scan function and media print function are not available, the CPU 102 finishes this process. As a result of the determination in the step S801, when at least one of the media scan function and media print function is usable, the CPU 102 determines whether the media print function is available (step S802).

As a result of the determination in the step S802, when the media print function is not available, the CPU 102 controls the UI controller 112 to display the media scan screen 506 on the operation unit 107 (step S803). In this way, when the media scan function is uniquely specified as a function that is selectable by a user from among the external-memory-device use functions because the media print function is not available, the setting screen concerning the media scan function is displayed on the operation unit 107 in the embodiment. Then, the CPU 301 finishes this process.

As a result of the determination in the step S802, when the media print function is available, the CPU 102 determines whether the media scan function is available (step S804).

As a result of the determination in the step S804, when the media scan function is not available, the CPU 102 controls the UI controller 112 to display the media print screen 507 on the operation unit 107 (step S805). In this way, when the media print function is uniquely specified as a function that is selectable by a user from among the external-memory-device use functions because the media scan function is not available, the setting screen concerning the media print function is displayed on the operation unit 107 in the embodiment. Then, the CPU 301 finishes this process.

As a result of the determination in the step S804, when the media print function is available, the CPU 102 controls the UI controller 112 to display the selection screen 502 on the operation unit 107 (step S806). When detecting a user's operation on the selection screen 502, the CPU 102 determines whether the detected user's operation is a press of the media scan button 503 (step S807).

As a result of the determination in the step S807, when the detected user's operation is a press of the media scan button 503, the CPU 102 executes the process in the step S803. As a result of the determination in the step S807, when the detected user's operation is not a press of the media scan button 503, the CPU 102 determines whether the detected user's operation is a press of the media print button 504 (step S808).

As a result of the determination in the step S808, when the detected user's operation is a press of the media print button 504, the CPU 102 executes the process in the step S805. As a result of the determination in the step S808, when the detected user's operation is not a press of the media print button 504, the CPU 102 determines whether the detected user's operation is a press of the close button 505 (step S809).

As a result of the determination in the step S809, when the detected user's operation is not a press of the close button 505, the CPU 102 returns the process to the step S807. As a result of the determination in the step S809, when the detected user's operation is a press of the close button 505, the CPU 102 controls the UI controller 112 to display the home screen 501 on the operation unit 107 (step S810) and finishes this process.

According to the embodiment mentioned above, when a function that is selectable by a user from among the external-memory-device use functions is uniquely specified, the setting screen concerning the uniquely specified function is displayed on the operation unit 107 in response to the connection of the external storage device 114 without displaying the selection screen 502. Thereby, when the external storage device 114 is connected, an unnecessary selection operation on the selection screen 502 is not required of a user, which improves the usability at the time of using an external-memory-device use function.

Moreover, the external-memory-device use functions are the media scan function and media print function in the embodiment mentioned above. Accordingly, the usability at the time of using the media scan function and media print function as the external-memory-device use functions is improved.

In the embodiment mentioned above, it is determined which of the selection screen 502 and the setting screen concerning a uniquely specified function is displayed in response to connection of the external storage device 114 on the basis of the function restriction information table 116 that manages the use propriety information about the media scan function and media print function. Thereby, the screen transition suitable for the use propriety states of the media scan function and media print function is controllable on the operation unit 107.

Moreover, the function restriction information table 116 is set up by a user in the embodiment mentioned above. Thereby, a user's intention is reflected to the control of the screen transition on the operation unit 107 mentioned above.

Furthermore, the function restriction information table 116 is set up on the basis of the failure states of the reader 109 and the printer 111 in the embodiment mentioned above. Thereby, the screen transition on the operation unit 107 mentioned above can be controlled on the basis of the failure states of the reader 109 and the printer 111 without imposing a setting operation through the function restriction setting screen 301 on a user.

In the embodiment mentioned above, the function restriction information table 116 is set up on the basis of the job-execution propriety states of the reader 109 and the printer 111. Thereby, the screen transition on the operation unit 107 mentioned above can be controlled on the basis of the job-execution propriety states of the reader 109 and the printer 111 without imposing a setting operation through the function restriction setting screen 301 on a user.

In the embodiment mentioned above, when use of either one of the media scan function and media print function is restricted on the basis of the setting values on the function restriction setting screen 301, the setting screen concerning the function of which use is not restricted on the basis of the setting value on the function restriction setting screen 301 is displayed on the operation unit 107 in response to the connection of the external storage device 114. Thereby, when the external storage device 114 is connected, an unnecessary selection operation on the selection screen 502 is not required of a user, which improves the usability at the time of using an external-memory-device use function.

Although the present invention is described with the embodiment mentioned above, the present invention is not limited to the embodiment mentioned above. For example, a mode of screen transition on the operation unit 107 may depend on detection states of specific events in the reader 109 and printer 111.

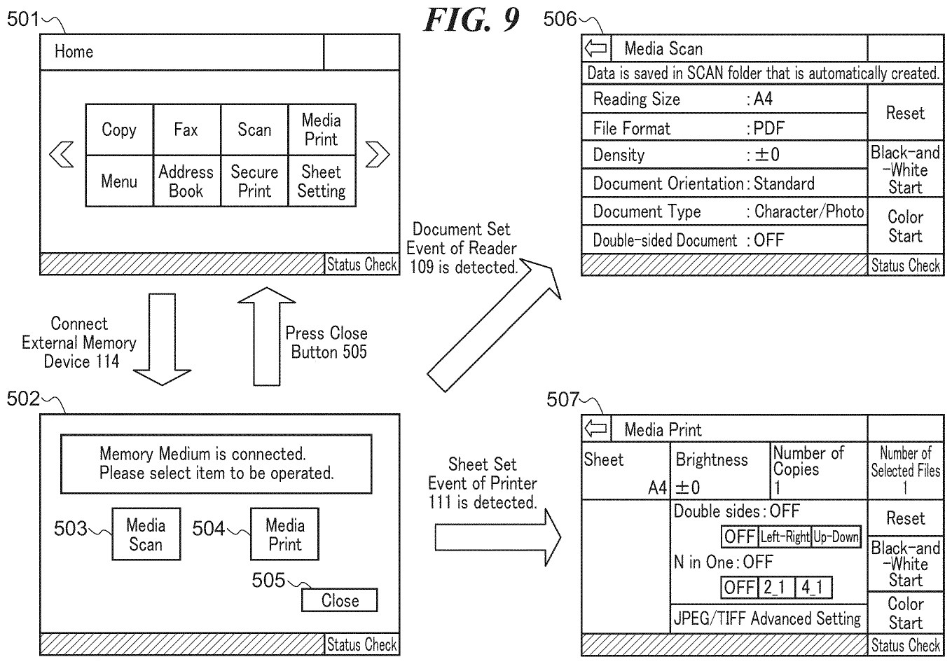

FIG. 9 is a view showing screen transition of a case where the image forming apparatus 100 in FIG. 1 is able to use both the media scan function and media print function.

When detecting occurrence of a reading document set event of the reader 109 in a state where the selection screen 502 is displayed on the operation unit 107, the display processing module 201 controls the UI controller 112 to switch the selection screen 502 displayed on the operation unit 107 to the media scan screen 506 as shown in FIG. 9.

Moreover, when detecting occurrence of a sheet set event of the printer 111 in the state where the selection screen 502 is displayed on the operation unit 107, the display processing module 201 controls the UI controller 112 to switch the selection screen 502 displayed on the operation unit 107 to the media print screen 507 as shown in FIG. 9.

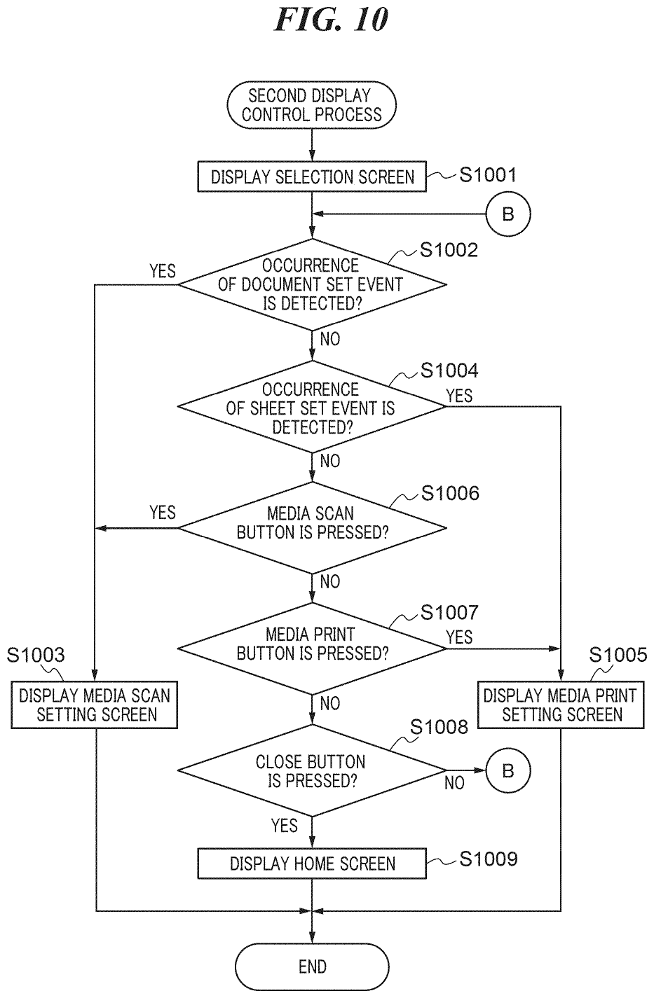

FIG. 10 is a flowchart showing procedures of a second display control process executed by the image forming apparatus in FIG. 1. The process in FIG. 10 is achieved when the CPU 102 executes programs stored in the ROM 103 and the storage device 105. The process in FIG. 10 is executed when connection of the external storage device 114 to the image forming apparatus 100 is detected in the state where the home screen 501 is displayed on the operation unit 107.

As shown in FIG. 10, the CPU 102 controls the UI controller 112 to display the selection screen 502 on the operation unit 107 (step S1001). Next, the CPU 102 determines whether occurrence of the reading document set event is detected (step S1002).

As a result of the determination in the step S1002, when occurrence of the reading document set event is detected, the CPU 102 controls the UI controller 112 to display the media scan screen 506 on the operation unit 107 (step S1003). In this way, when the media scan function is uniquely specified as a function that is selectable by a user from among the external-memory-device use functions because the reading document set event is detected, the setting screen concerning the media scan function is displayed on the operation unit 107 in the embodiment. Next, the CPU 102 finishes this process.

As a result of the determination in the step S1002, when occurrence of the reading document set event is not detected, the CPU 102 determines whether occurrence of the sheet set event is detected (step S1004).

As a result of the determination in the step S1004, when occurrence of the sheet set event is detected, the CPU 102 controls the UI controller 112 to display the media print screen 507 on the operation unit 107 (step S1005). In this way, when the media print function is uniquely specified as a function that is selectable by a user from among the external-memory-device use functions because the sheet set event is detected, the setting screen concerning the media print function is displayed on the operation unit 107 in the embodiment. Next, the CPU 102 finishes this process.

As a result of the determination in the step S1004, when occurrence of the sheet set event is not detected, and when a user's operation on the selection screen 502 is detected, the CPU 102 determines whether the detected user's operation is a press of the media scan button 503 (step S1006).

As a result of the determination in the step S1006, when the detected user's operation is a press of the media scan button 503, the CPU 102 executes the process in the step S1003. As a result of the determination in the step S1006, when the detected user's operation is not a press of the media scan button 503, the CPU 102 determines whether the detected user's operation is a press of the media print button 504 (step S1007).

As a result of the determination in the step S1007, when the detected user's operation is a press of the media print button 504, the CPU 102 executes the process in the step S1005. As a result of the determination in the step S1007, when the detected user's operation is not a press of the media print button 504, the CPU 102 determines whether the detected user's operation is a press of the close button 505 (step S1008).

As a result of the determination in the step S1008, when the detected user's operation is not a press of the close button 505, the CPU 102 returns the process to the step S1002. As a result of the determination in the step S1008, when the detected user's operation is a press of the close button 505, the CPU 102 controls the UI controller 112 to display the home screen 501 on the operation unit 107 (step S1009) and finishes this process.

In the embodiment mentioned above, it is determined which of the selection screen 502 and the setting screen concerning a uniquely specified function is displayed in response to connection of the external storage device 114 on the basis of the detection states of specific events in the reader 109 and printer 111. This improves the usability of an external-memory-device use function at the time of detecting a specific event.

Moreover, when occurrence of the reading document set event is detected, the media scan screen 506 is displayed on the operation unit 107 in the embodiment mentioned above. This improves the usability at the time of using the media scan function without imposing an unnecessary selection operation on a user.

Moreover, when occurrence of the sheet set event is detected, the media print screen 507 is displayed on the operation unit 107 in the embodiment mentioned above. This improves the usability at the time of using the media print function without imposing an unnecessary selection operation on a user.

Although the embodiment mentioned above describes the case where the present invention is applied to the image forming apparatus, the present invention is not limited to the image forming apparatus. For example, the present invention may be applied to devices, such as a PC, a smart phone, and a tablet terminal, that display a selection screen that prompts a user to select a use function from among the external-memory-device use functions that are specific functions using an external storage device connected.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{T}n, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-123822, filed Jul. 2, 2019, which is hereby incorporated by reference herein in its entirety.

What is claimed is:

1. An image forming apparatus comprising:
a memory device that stores a set of instructions; and
at least one processor that executes the set of instructions to:
display, in a case where a function that is selectable by a user is uniquely specified from among specific functions that use an external storage device connected, a setting screen concerning the uniquely specified function in response to connection of the external storage device; and
display a selection screen that prompts the user to select a use function from among the specific functions in response to connection of the external storage device in a case where a function that is selectable by the user is not uniquely specified from among the specific functions.

2. The image forming apparatus according to claim 1, further comprising:
a reader that reads a document and generates image data of the document concerned; and
a printer that performs a print process,
wherein the specific functions include a first function that stores the image data generated by the reader into the external storage device and a second function that performs the print process based on print data stored in the external storage device.

3. The image forming apparatus according to claim 2, wherein the at least one processor determines which of the selection screen and the setting screen concerning the uniquely specified function is displayed in response to connection of the external storage device according to use propriety information about the first function and the second function.

4. The image forming apparatus according to claim 3, wherein the use propriety information is set up by the user.

5. The image forming apparatus according to claim 3, wherein the use propriety information is set up based on failure states of the reader and the printer.

6. The image forming apparatus according to claim 3, wherein the use propriety information is set up based on job-execution propriety states of the reader and the printer.

7. The image forming apparatus according to claim 2, wherein the at least one processor determines which of the selection screen and the setting screen concerning the uniquely specified function is displayed in response to connection of the external storage device according to detection states of specific events in the reader and printer.

8. The image forming apparatus according to claim 7, wherein the at least one processor displays a setting screen concerning the first function in a case where occurrence of an event showing that a document has been set to the reader is detected.

9. The image forming apparatus according to claim 7, wherein the at least one processor displays a setting screen concerning the second function in a case where occurrence of an event showing that a sheet has been set to the printer is detected.

10. An image forming apparatus comprising:
a memory device that stores a set of instructions; and
at least one processor that executes the set of instructions to:
display a function restriction setting screen that enables setting of restricting use of at least one of a first function and a second function that use an external storage device connected;
display a selection screen that prompts a user to select a use function from among the first function and the second function in response to connection of the external storage device in a case where use of neither the first function nor the second function is restricted based on the setting on the function restriction setting screen; and
display, in a case where use of one of the first function and the second function is restricted based on the setting on the function restriction setting screen, a setting screen concerning a function of which use is not restricted based on the setting on the function restriction setting screen.

11. The image forming apparatus according to claim 10, further comprising:
a reader that reads a document and generates image data of the document concerned; and
a printer that performs a print process,
wherein the first function stores the image data generated by the reader into the external storage device, and
wherein the second function performs the print process based on print data stored in the external storage device.

12. A control method for an image forming apparatus, the control method comprising:
displaying, in a case where a function that is selectable by a user is uniquely specified from among specific functions that use an external storage device connected, a setting screen concerning the uniquely specified function in response to connection of the external storage device; and
displaying a selection screen that prompts the user to select a use function from among the specific functions in response to connection of the external storage device in a case where a function that is selectable by the user is not uniquely specified from among the specific functions.

13. A control method for an image forming apparatus, the control method comprising:
displaying a function restriction setting screen that enables setting of restricting use of at least one of a first function and a second function that use an external storage device connected;
displaying a selection screen that prompts a user to select a use function from among the first function and the second function in response to connection of the external storage device in a case where use of neither the first function nor the second function is restricted based on the setting on the function restriction setting screen; and
displaying, in a case where use of one of the first function and the second function is restricted based on the setting on the function restriction setting screen, a setting screen concerning a function of which use is not restricted based on the setting on the function restriction setting screen in response to connection of the external storage device.

14. A non-transitory computer-readable storage medium storing a control program causing a computer to execute a control method for an image forming apparatus, the control method comprising:
displaying, in a case where a function that is selectable by a user is uniquely specified from among specific functions that use an external storage device connected, a setting screen concerning the uniquely specified function in response to connection of the external storage device; and
displaying a selection screen that prompts the user to select a use function from among the specific functions in response to connection of the external storage device in a case where a function that is selectable by the user is not uniquely specified from among the specific functions.

15. A non-transitory computer-readable storage medium storing a control program causing a computer to execute a control method for an image forming apparatus, the control method comprising:
displaying a function restriction setting screen that enables setting of restricting use of at least one of a first function and a second function that use an external storage device connected;
displaying a selection screen that prompts a user to select a use function from among the first function and the second function in response to connection of the external storage device in a case where use of neither the first function nor the second function is restricted based on the setting on the function restriction setting screen; and
displaying, in a case where use of one of the first function and the second function is restricted based on the setting on the function restriction setting screen, a setting screen concerning a function of which use is not restricted based on the setting on the function restriction setting screen in response to connection of the external storage device.
